(19) United States
(12) Patent Application Publication
(10) Pub. No.: US 2003/0202119 A1
(43) Pub. Date: Oct. 30, 2003

(54) Video processing for electronic cinema

(75) Inventor: Joseph Keith Masters, Mahopac, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/356,305

(22) Filed: Jan. 31, 2003

Related U.S. Application Data
(60) Provisional application No. 60/376,729, filed on Apr. 30, 2002.

(51) Int. Cl. H04N 7/01

(52) U.S. Cl. 348/441

(57) ABSTRACT

A video processing system directly upsamples cinema material to a video frame rate that is a multiple of the fundamental cinema frame rate of 24 frames per second. A video display processor is configured to directly accept video images at a variety of frame rates, including the cinema frame rate of 24 fps. A frame buffer is suitably configured to accept the video images at the recorded frame rate and provides a corresponding video stream at a frame rate that is an integer multiple of the recorded frame rate. By providing the video stream at this frame rate, the anomalies and artifacts caused by non-integer or non-uniform upsampling are avoided. Correspondingly, a video processor is configured to provide the video images at standard television resolutions, but at the original recorded frame rate, to minimize temporal anomalies and artifacts.

This application claims the benefit of U.S. Provisional Application, serial No. 60/376,729, filed Apr. 30, 2002, Attorney Docket US02.0133P.

### TECHNICAL FIELD

This invention relates to the field of consumer electronics, and in particular to a method and system for processing video information corresponding to cinema recordings.

### BACKGROUND AND SUMMARY OF THE INVENTION

Professional cinema productions are typically recorded at 24 frames per second (fps). Double-shuttering is effected when the recording is projected, for an apparent frame rate of 48 frames per second. Commercial television broadcasts are typically processed, in the United States, at 30 frames per second (fps), interlaced, wherein each frame is rendered as two fields of alternating odd-even lines of the frame, to provide an effective display rate of 60 fields per second. Newer television standards, such as HDTV, include 60 frames per second, non-interlaced. The standard rate of 60 frames per second has been maintained primarily to provide compatibility with existing cathode ray tube (CRT) technology, wherein the horizontal and vertical sweep circuitry is integrally designed to sweep an electron beam across the screen at the intended rate. CRT displays that accommodate multiple rates are substantially more complex, and therefore more costly, than single frame rate displays.

To provide compatibility between cinema recordings and conventional television systems, 24 fps cinema recordings, such as DVD recordings, are “3-2 upsampled” to provide a 60 field per second rate. That is, a first cinema frame provides the image for three periods, then a second video frame provides the next image for two periods, and so on. Because the five periods at 60 fps consume 5/60 seconds, which is equal to the duration of the two cinema frames at 24 fps (2/24=5/60), the overall temporal playback rate is maintained. This upsampling, however, produces visual artifacts that are discernible by many viewers. When an image is projected for two 1/60 second periods, the effective update rate is 1/30 second; however, when an image is projected for three periods, the effective update rate is 1/20 second. As is commonly known, most humans will detect a flicker effect at 20 updates per second. Although the alternating 30 update per second rate diminishes this effect, the non-uniformity of the image update rate also contributes to the anomalies and visual artifacts that are produced by this 3-2 upsampling technique.

Common video standards are also based on a 60 fps frame rate. The SMPTE 292 specification, for example, specifies a 1280×720 HDTV (High Definition Television) format at 60 frames per second. The SMPTE 292 specification also includes higher resolution formats, at 24 fps, 30 fps, and 60 fps, but the common “television standard” of 1280×720 pixels is only specified at 60 fps.

Advanced video processing systems for television are also typically based on a 60 fps assumed standard. For example, common LCOS (Liquid Crystal On Silicon) projection displays are configured to project 1280×720 HDTV images at 60 frames per second. In such a display, the image is projected as a sequence of single-color images. The display projects the red information of the image, the green information of the image, and the blue information of the image. This sequential display of the individual colors, however, introduces visual anomalies, and to avoid these anomalies, each frame is repeated three times, for an effective display rate of 180 fps, the color fields occurring at a rate of 540 (3*180) fields per second. In a conventional LCOS system, the video processing within the LCOS is merely the sequential extraction of the appropriate color information from a conventional 60 fps video sequence, and a thrice repeated display of each of the color fields.

By maintaining a common 60 fps standard, existing techniques for upsampling cinema material provide compatibility between conventional cinema material and ongoing television advancements. However, because the original format of cinema material is not directly renderable at 60 fps, the aforementioned visual artifacts caused by the 3-2 upsampling remain.

FIG. 1 illustrates an example block diagram of a conventional video processing system 100 for rendering cinema material 110 on a television display 160. Typically, the cinema material 110 is stored in as encoded image information. This encoding may be provided for security purposes, or to conserve storage space, or a combination of both. Commonly, the encoded cinema material 110 comprises an MPEG encoding of the cinema images, although other forms of encoding are becoming increasingly prevalent. Of note, U.S. Pat. No. 6,289,132, “APPARATUS AND METHOD FOR OPTIMIZED COMPRESSION OF INTERLACED MOTION IMAGES”, issued Sep. 11, 2001 to Kenbe D. Goertzen, discloses wavelet transform techniques that are particularly well suited for the compression of cinema-quality images, and is incorporated by reference herein. Because the compression of this referenced patent is based on a wavelet-based encoding and compression of the entire image, as compared to MPEG's encoding and compression of macroblocks, the decoding of the wavelet-based encodings offer the promise of higher quality than MPEG decodings, and degradations of the wavelet-based decodings do not exhibit the typical macroblock artifacts and anomalies produced by a degraded MPEG decoding.

In the conventional system, a processor 120 includes a decoder/scaler 130 that is configured to decode the encoded image information 110, and to scale the decoded image to an existing display-resolution standard. For example, the “QuVIS Digital Mastering Codec” product that is based on the referenced U.S. Pat. No. 6,289,132 is configured to process encoded image information and to produce a sequence of images conforming to selectable SMPTE 292 standards. As noted above, the common SMPTE 292 standard for HDTV is a 60 frame per second sequence of 1280×720 pixel images. The decoder/scaler 130 decodes the encoded information and scales it to a standard HDTV resolution, such as 1280×720, and, as discussed above, a 3-2 upsampler 140 provides the corresponding scaled images at the standard frame rate of 60 frames per second. Thereby, at the output of the processor 120, image frames corresponding to the cinema material 110 are provided in a television-rendering compatible format.

A television-rendering device 150 receives the standard-formatted image frames and provides these images to the display device 160 at the provided input frame rate of 60 frames per second. Because the input frame rate is at the standard 60 frames per second, the decoded and 3-2 upsampled cinema material is easily rendered on a conventional television rendering system 150. However, as noted above, the 3-2 upsampling provides visual artifacts and anomalies that are noticeable by many viewers.

To reduce the occurrence of visual artifacts in the upsampling of conventional cinema material for rendering, a method and system are provided that directly upsamples cinema material to a video frame rate that is a multiple of the fundamental cinema frame rate of 24 frames per second. A video display processor is configured to directly accept video images at a variety of frame rates, including the cinema frame rate of 24 fps. A frame buffer is suitably configured to accept the video images at the recorded frame rate and provides a corresponding video stream at a frame rate that is an integer multiple of the recorded frame rate. By providing the video stream at this frame rate, the anomalies and artifacts caused by non-integer or non-uniform upsampling are avoided. Correspondingly, a video processor is configured to provide the video images at standard television resolutions, but at the original recorded frame rate, to minimize temporal anomalies and artifacts.

### BRIEF DESCRIPTION OF THE DRAWINGS

The invention is explained in further detail, and by way of example, with reference to the accompanying drawings wherein:

FIG. 1 illustrates an example block diagram of a conventional video processing system for rendering cinema material on a television display.

FIG. 2 illustrates an example block diagram of a video processing system for rendering cinema material in accordance with this invention.

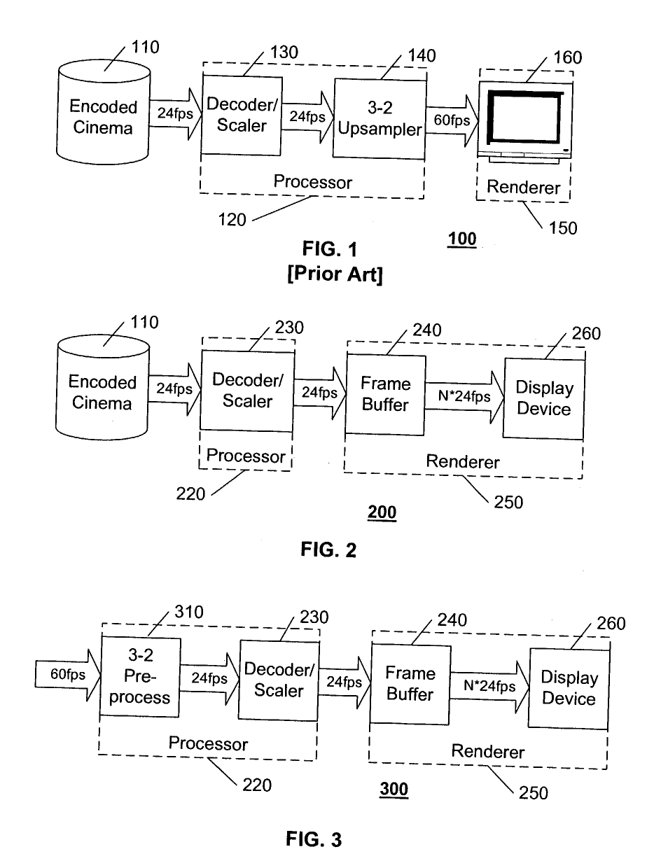

Throughout the drawings, the same reference numerals indicate similar or corresponding features or functions.

### DETAILED DESCRIPTION OF THE INVENTION

This invention is premised on the observation that newer technologies for rendering video images, such as LCDs for portable televisions, plasma displays for wall mountable televisions, and LCOS devices for projection television, do not rely upon prior CRT electron-beam sweeping techniques, and hence are not, per se, constrained by standards that have been developed for conventional CRT display techniques. This invention is also premised on the observation that newer technologies for rendering video images contain the core ingredients for easily effecting a more versatile approach to video image processing. This invention is also premised on the observation that newer technologies for rendering video images employ techniques that may be exploited to provide an apparent refresh rate that exceeds the actual image information refresh rate. Specifically, as noted above, a conventional LCOS device operates at 180 frames per second, and a reliance on existing 60 fps standards and practices introduces constraints that inhibit the technology's true potential for quality displays, particularly when dealing with 24 fps cinema recordings.

FIG. 2 illustrates an example block diagram of a video processing system 200 for rendering of cinema material 110 in accordance with this invention. As is common in the art, advanced video rendering systems 250, such as LCDs, Plasma Displays, and LCOS devices, typically include a frame buffer 240 that is configured to receive frames of information from a processing system, such as a DVD player, for subsequent display on the display device 260. Because these newer technologies do not rely on a continuous sweep of an electron beam across a display area, and instead, typically render the image in a column by column manner, the frame buffer 240 is used to receive an entire frame of information before commencing the display of the frame. Typically, the frame buffer 240 is sufficiently sized to contain at least two full frames of video information, so that while one frame is being dynamically loaded, the other (prior) frame is being displayed.

In accordance with this invention, the rendering system 250 is configured to receive image information in its original recording frame rate, nominally 24 frames per second for cinema image information, and to provide this information at an integer multiple of this incoming frame rate. By providing the image information at a uniform rate that is a multiple of the incoming frame rate, the anomalies and visual artifacts caused by the non-uniform 20 fps-30 fps frame rates of the conventional 3-2 upsampling process are eliminated. Further, although the actual image update rate remains at 24 frames per second, the apparent update rate is increased, due to the technologies employed for image rendering, and particularly the newer technologies for projection displays. As is known in the art of cinematography, the apparent image update rate can be increased by “double shuttering” the projection of film images. In a professional film projection system, such as used in movie theatres, each image frame is projected twice, at a shutter rate of 48 projections per seconds. Although the actual frame rate is 24 frames per second, the stroboscopic effects of double-shuttering apparently trick the human visual perceptive system into perceiving an apparently higher image refresh rate.

In a conventional LCOS projection display device, each image is projected as a sequence of three frames of three single-color images. This repeated-display of the same image as a sequence of three single-color images has been found to have similar advantageous visual effects as the aforementioned double-shuttering process. That is, although the repetition of the same image does not increase the actual image update rate, the process used to display these repetitions have the effect of increasing the apparent image update rate, thereby reducing or eliminating any flicker effects.

In a preferred embodiment of this invention, the display rate of the images from the frame buffer 240 is at least six or seven times the input image frame rate. A display rate of seven times the input cinema 24 fps rate, or 168 frames per second, is particularly well suited for a quality display of cinema image information, and consistent with existing LCOS technologies. In an LCOS projection display device, because each displayed image is produced by a sequence of three single-color images that provide the aforementioned shutter-effect, the display of 24 fps cinema as seven repeated frames is perceived as a smoothly continuous display by most, if not all, viewers.

In combination with the aforementioned advantages of image-based wavelet encodings of U.S. Pat. No. 6,289,132, this invention offers the promise of extremely high quality reproductions of cinema image information from wavelet-compressed recordings of cinema productions. In a preferred embodiment, the video processor 220, such as one based on the reference patent, is configured to provide the decoded images at the original image recording rate, independent of existing television standards. As noted above, a common HDTV standard is 1280×720 pixel images at 60 frames per second. Preferably, the decoder/scaler 230 in the processor 220 is configured to provide the decoded images at this 1280×720 resolution, but at the cinema frame rate of 24 frames per second.

In another preferred embodiment of this invention, the processor 220 is configured to detect 3-2 upsampled cinema, such as a movie that is transmitted by a broadcaster at 60 fps, and to pre-process this 3-2 upsampled cinema to recreate the original images at 24 fps, as illustrated at 310 in FIG. 3. This recreated image stream at 24 fps is provided to the renderer 250, for display at an integer multiple of the 24 fps rate, preferably at a rate of at least six times the input rate. Equivalently, if the decoder/scaler 230 is configured to decode and scale the images at the incoming rate of 60 fps, the 3-2 downsampling of the sequence of images to form the 24 fps sequence of images may be preformed after the decoder/scaler 230.

The foregoing merely illustrates the principles of the invention. It will thus be appreciated that those skilled in the art will be able to devise various arrangements which, although not explicitly described or shown herein, embody the principles of the invention and are thus within its spirit and scope. For example, although the invention is presented herein as a simple re-display of the same image a number of times, additional advantages may be gained by providing interpolated images in lieu of repetitive images. That is, in lieu of displaying each image in a sequence of repeated images, the renderer 250 may be configured to provide a first image, and then a created image that is the average of this first image and the next image in the sequence, and then the next image, and then another averaged image, and so on. These and other system configuration and optimization features will be evident to one of ordinary skill in the art in view of this disclosure, and are included within the scope of the following claims.

I claim:

1. A video processing system comprising:
a frame buffer that is configured to:
receive incoming video images at a cinema frame rate of 24 frames per second, and
providing outgoing video images at an outgoing frame rate that is an integer multiple of the cinema frame rate, and
a display system that is configured to render the outgoing video images at a standard television resolution at the outgoing frame rate.

2. The video processing system of claim 1, further comprising:
a preprocessor that is configured to:
receive processed video images at a video frame rate of 60 frames per second, and
provide the incoming video images at the cinema frame rate.

3. The video processing system of claim 1, wherein
the outgoing video images comprise sequences of single color images corresponding to the incoming video images.

4. The video processing system of claim 3, wherein
the sequences of single color images correspond to sequences of three colors, and
the outgoing video images correspond to a repetition of the sequences of three colors at least six times for each incoming video image.

5. The video processing system of claim 1, wherein
the output frame rate is at least six times the cinema frame rate.

6. The video processing system of claim 1, wherein
the standard television resolution is 1280 by 720 pixels.

7. The video processing system of claim 1, further including
a video processor that is configured to:
receive encoded video information from a storage device, and
decode the encoded video information to form the incoming video images, wherein
the encoded video information is encoded at the cinema frame rate.

8. The video processing system of claim 7, wherein
the encoded video information is encoded at a first resolution that does not correspond to the standard television resolution, and
the video processor is further configured to form the incoming video images at the standard television resolution.

9. The video processing system of claim 8, wherein
the encoded video information is encoded using one of:
wavelet compression, and
macroblock compression.

10. A video processor that is configured to:
receive encoded video information whose encoding is based on a cinema frame rate of 24 frames per second, and
decode the encoded video information to form decoded video images at the cinema frame rate and at a standard television resolution of 1280 by 720 pixels.

11. The video processor of claim 10, wherein
the encoded video information is encoded at 60 fps, based on a 3-2 upsampling of a sequence of images at the cinema frame rate.

12. The video processor of claim 10, wherein
the encoded video information is encoded at a first resolution that does not correspond to the standard television resolution.

13. The video processor of claim 10, wherein
the encoded video information is encoded using one of:
wavelet-based compression, and
macroblock-based compression.

14. A method of rendering a sequence of images that are based on a cinema frame rate of 24 frames per second, comprising:
receiving the sequence of images, and
rendering the video images at an integer multiple of the cinema frame rate at a standard television resolution.

15. The method of claim 14, further comprising:
receiving the sequence of images at a broadcast frame rate of 60 frames per second, and
providing therefrom the video images at the cinema frame rate.

16. The method of claim 14, wherein
rendering the video images includes
rendering sequences of single color images corresponding to the video images.

17. The method of claim 16, wherein
the sequences of single color images correspond to sequences of three colors, and
the rendering of the video images further includes
repeating the rendering of the sequences of three colors at least six times for each video image.

18. The method of claim 14, wherein
the integer multiple is at least six.

19. The method of claim 14, wherein
the standard television resolution is 1280 by 720 pixels.

20. The method of claim 14, further including:
receiving encoded video information from a storage device, and
decoding the encoded video information to form the incoming video images, wherein
the encoded video information is encoded at the cinema frame rate.

21. The method of claim 20, wherein
the encoded video information is encoded at a first resolution that does not correspond to the standard television resolution, and
the method further includes:
scaling the video images to the standard television resolution.

22. The method of claim 20, wherein
the encoded video information is encoded using one of:
wavelet compression, and
macroblock compression.
